(19) United States
(12) Patent Application Publication
(10) Pub. No.: US 2014/0263691 A1
(43) Pub. Date: Sep. 18, 2014

(54) PAINT REMOVAL VEHICLE WITH GRAY WATER SEPARATION AND RECYCLING

(71) Applicant: FRIDAY HARBOUR HOLDINGS, LLC, Adams Center, NY (US)

(72) Inventor: Joel Rarick, Richland, NY (US)

(73) Assignee: FRIDAY HARBOUR HOLDINGS, LLC, Adams Center, NY (US)

(21) Appl. No.: 14/212,232

(22) Filed: Mar. 14, 2014

Related U.S. Application Data
(60) Provisional application No. 61/781,673, filed on Mar. 14, 2013.

(51) Int. Cl. B05B 9/04

(52) U.S. Cl. CPC B05B 9/0403
USPC 239/1; 239/124

(57) ABSTRACT

A vehicle and process for removing materials, such as paint, rubber, markings, or cure compounds, from a surface such as a road or airport runway. The vehicle comprises a fresh water tank, a water pressure pump, a blast head, a vacuum tank, a gray water tank, and a filter body.

### RELATED APPLICATIONS

This application claims priority to U.S. Provisional Patent Application Ser. No. 61/781,673, entitled PAINT REMOVAL VEHICLE WITH GRAY WATER SEPARATION AND RECYCLING, filed on Mar. 14, 2013, the entire content of which is hereby incorporated by reference.

### FIELD OF THE INVENTION

The present disclosure relates to removal of materials from surfaces, for example paint from road or runway surfaces, and more specifically to an ultra-high pressure paint removal vehicle with gray water separation and recycling.

### BACKGROUND OF THE INVENTION

The removal of materials such as paint from airport runways and taxiways poses a significant expense and time management issue for airports. Similarly, removal of paint from roads for routine maintenance or creation of detours is an expensive process.

Moreover, the volumes of water required for the removal of paint and other materials from surfaces presents a significant environmental concern. Equipment manufacturers have tried unsuccessfully to vacuum and reuse blasted water by filtering it and using water directly from the filter to supply the blast head.

The present disclosure provides runway rubber removal in the form of an ultra-high pressure water blasting system which utilizes a gray water tank with a filter system. The disclosure provides a significantly higher rate of paint and material removal, more complete paint removal, and more environmentally friendly practices compared with conventional technology.

### SUMMARY OF THE INVENTION

The present disclosure relates to the removal of paint from road and runways surfaces using ultra-high pressure water, and provides a vehicle and process for removing materials, such as paint, rubber, markings, or cure compounds, from a surface such as a road or airport runway.

In one embodiment, the disclosure provides a paint removal vehicle comprising a fresh water tank, a water pressure pump, a blast head, a vacuum tank, a gray water tank, and a filter body.

The present disclosure provides vehicles capable of removing materials from a surface with a width of up to 30 inches in a single pass. The paint removal vehicles of the present disclosure are capable of reusing gray water, resulting in decreased water use. The paint removal vehicles of the present disclosure are also cost-efficient, requiring less refilling time compared with conventional vehicles.

The disclosure further provides a process for removal of materials from a surface, such as removing paint or rubber from a road or airport runway.

### BRIEF DESCRIPTION OF THE SEVERAL VIEWS OF THE DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 shows a side view and a top view of a vehicle in an embodiment of the present disclosure.

FIG. 2 shows a process of removing materials from a surface in accordance with an embodiment of the present disclosure.

TABLE 1 depicts a 13-hour shift of a vehicle in accordance with an exemplary embodiment of the present disclosure.

TABLE 2 depicts a 13-hour shift of a conventional vehicle without gray water recycling.

### DETAILED DESCRIPTION OF THE INVENTION

The present disclosure relates to paint removal from roads or runways, and more specifically to an ultra-high pressure vehicle with gray water separation and recycling.

The present disclosure provides a vehicle and process for removing materials, such as paint, rubber, markings, or cure compounds, from a surface such as a road or airport runway.

FIG. 1 shows a paint removal vehicle 100 in accordance with an exemplary embodiment of the present disclosure. The vehicle 100 comprises a fresh water tank 101, a water pressure pump 102, a blast head 103, a vacuum tank 106, a gray water tank 108 and a filter body 110. In this exemplary embodiment of the present disclosure, the fresh water tank 101 holds approximately 1,500 to 4,500 gallons.

Certain embodiments of the disclosure comprise a water pressure pump 102, such as a 40,000 PSI water pressure pump with an integrated vacuum pump 104, capable of delivering pressurized water to a blast head 103. The water pressure pump 102 can have a pressure capability of between approximately 32,000 and 40,000 PSI, a flow range of between approximately 10 to 14 gallons per minute, can be a roots blower, such as a 1,400 CFM roots blower, or can have other suitable design parameters. The water pressure pump 102 can be mounted on a fuel tank 105, such as a structural 600 gallon fuel tank, or other suitable structures. The water pressure pump 102 and fuel tank 105 can have dimensions of approximately 12 feet in length, 8 feet in width, and not more than 10 feet in height, or other suitable dimensions. The water pressure pump 102 can have a filter 111 for filtering water provided from the fresh water tank 101, before delivering the pressurized water to the blast head 103, or other suitable water cleaning systems. The blast head 103 removes surface materials including paint and rubber from a surface to be sprayed, such as an airport runway. The blast head 103 can further comprise an integrated vacuum or vacuum ports, and can vacuum sprayed water, liquid gray water, and solid debris into a vacuum tank 106. In one embodiment of the present disclosure, the blast head 103 can comprise one or more vacuum ports operating in conjunction with the integrated vacuum pump 104 of the water pressure pump 102 to deliver vacuumed liquid and debris to the vacuum tank 106. Once the vacuumed liquid and debris mixture is delivered to the vacuum tank 106, the heavy solid debris will settle at the bottom of the vacuum tank. In one embodiment of the present disclosure, the vacuum tank 106 can further comprise a sump filter, a membrane filter, a cartridge filter or other suitable filters 114 for separating the solid debris from the liquid gray water.

Certain embodiments of the disclosure comprise a gray water tank 108. The gray water tank can hold approximately 2,500 to 5,000 gallons or other suitable amounts. The gray water tank 108 can receive gray water from the vacuum tank 106 using a transfer pump 107. The gray water tank 108 can be connected to a filter body 110, such that gray water can be pumped from the gray water tank 108 to the filter body 110. Gray water can be continuously filtered from the gray water tank 108 to the filter body 110 using a filter pump 109, for example a high volume pump or other suitable pumps. In one embodiment, the high volume filter pump 109 is a Subaru PTD301T-317 GPM (3″) Diesel Trash Pump (Robin America Inc, Lake Zurich, Ill.).

In one embodiment of the present disclosure, the filter body 110 includes a plurality of filters of varying filter ratings. For example, the filter body 110 can include filters ranging from about 5 microns to about 100 microns, or can be a sump filter, a membrane filter, a cartridge filter or other suitable filters. The filter body 110 can be configured to include a back flush mechanism or other suitable filter cleaners.

In one embodiment of the present disclosure, the filter body 110 can receive gray water from the bottom of the gray water tank 108 via the filter pump 109 which then circulates the filtered gray water back into the top of the gray water tank 108.

In some embodiments, a vehicle is equipped with rearview cameras, monitors, auxiliary lights, or similar safety features. For example, the vehicle can include a low water level shutdown 112 for the fresh water tank 101 wherein upon detecting low water supply in the fresh water tank 101, the shutdown automatically turns off the water pressure pump 102. Additionally, the vehicle can include water level monitors 113 for the fresh water tank 101, the vacuum tank 106, and the gray water tank 108. Additionally, the vehicle can include pressure monitors 115 for measuring pressure in the filter body 110. In one embodiment of the present disclosure, at least one of these monitors is coupled with a controller capable of user-operation or programming to control the operation of the water removal vehicle.

The present disclosure provides vehicles capable of removing materials from a surface with a width of approximately 11 to 30 inches in a single pass. The paint removal vehicles of the present disclosure are capable of reusing gray water, resulting in decreased water use. The paint removal vehicles of the present disclosure are also cost-efficient, requiring less refilling time compared with conventional vehicles.

In some embodiments, the present disclosure provides a process for removal of materials from a surface, such as removing paint or rubber from a road or airport runway. The process comprises the steps of:
1) loading, wherein the fresh water tank 101 and the gray water tank 108 are supplied with clean water;
2) operation, wherein the water pressure pump 102 is engaged,
wherein the fresh water tank 101 supplies water to the water pressure pump 102,
wherein the water pressure pump 102 supplies pressurized water to the blast head 103,
wherein the blast head 103 sprays water to remove materials from the surface and vacuums water and materials to send to the vacuum tank 106, and
wherein operation is continued until the fresh water tank 101 is empty or the vacuum tank 106 is full;
3) dewatering/reloading, wherein clean water is pumped from the gray water tank 108 to the fresh water tank 101 until 101 is full,
wherein gray water is pumped from the vacuum tank 106 to the gray water tank 108, and
wherein the gray water tank 108 is continuously circulated to the filter body 110 with a high volume filter pump 109;
4) step 2) is repeated;
5) the process is completed, wherein step 3) is repeated, and wherein water from the gray water tank 108 is pumped into a designated waste water area.

FIG. 2 is a diagram of a process 200 for removal of materials from a surface in accordance with an exemplary embodiment of the present disclosure. Process 200 can be implemented in hardware or a suitable combination of hardware and software, and can be one or more software systems operating on a processor or processors.

Process 200 begins at 202, where a paint removal vehicle is provided. At 204, the vehicle's fresh water tank and gray water tank are loaded with clean water. Next, the vehicle begins operation 206 where the fresh water tank delivers a fresh water supply to the water pressure pump which in turn delivers a pressurized water supply of approximately 40,000 PSI to the blast head to remove materials from a surface. The blast head sprays the pressurized water supply and vacuums the sprayed water, liquid gray water, and solid debris which are then delivered to the vacuum tank. Operation 206 continues until it is determined that either the fresh water tank is empty or the vacuum tank is full 208. In one embodiment of the present disclosure, the fresh water tank further comprises a low water shutoff, water level monitor, or other suitable means for determining the level of the fresh water tank. Additionally, the vacuum tank can comprise a level monitor or other suitable means for determining the level of the vacuum tank.

At 210, the fresh water supply from the gray water tank is used to reload the fresh water tank. After the fresh water tank is reloaded, the liquid gray water supply from the vacuum tank is pumped into the gray water tank via a transfer pump. Next, the filter pump begins to continuously filter 212 the gray water supply from the gray water tank to the filter body. After passing through the filter body, the gray water supply reenters the gray water tank.

The steps of operating the vehicle 206, reloading the fresh water tank and transferring the vacuum tank's gray water supply to the gray water tank 210, and continuous filtering 212, are repeated until it is determined that the paint removal is completed 214. Once the paint removal is completed 214, the gray water supply in the gray water tank is disposed of in a designated waste area 216.

The present disclosure provides significant environmental advantages over conventional technology. The process of the present disclosure provides for removal of debris after cleaning through use of the vacuum feature of the blast head.

The present disclosure also provides more production per hour when compared with conventional vehicles and processes. The ability to clear more surface of unwanted materials such as paint or rubber in a shorter time allows for shorter facility closures. For example, an airport runway can be completely cleared during a relatively short overnight closure.

The vehicle and process of the present disclosure require fewer stops to replenish water supplies, thereby reducing the amount of time spent clearing a surface. For example, a road or airfield can be cleaned in a shorter amount of time, allowing the facility to reopen to traffic sooner.

The vehicle and process of the present disclosure also require fewer movements of the vehicle in a closed area, meaning that there are fewer opportunities for a surface incident or incursion.

The present disclosure provides increased production per hour worked, which lowers operating costs for a contractor and allows him to offer services at a lower price, and to offer more projects per year to clients.

The vehicle and process of the present disclosure can be used in paint removal for a road or runway, airway rubber removal and ramp cleaning, cure compound removal, sanitation vehicles for roads, graffiti removal, deicing vehicles, and fire trucks which have limited access to water sources, such as in rural areas.

EXAMPLE 1

Tables 1 and 2 show an exemplary 13 hour shift for a 40,000 PSI vehicle with gray water recycling according to the present disclosure (Table 1), compared with a conventional 40,000 PSI vehicle (Table 2). The theoretical 40,000 PSI vehicle with gray water recycling has a 2,000 gallon fresh water tank, and a 3,000 gallon gray water tank. The conventional 40,000 PSI vehicle has only a 2,000 gallon fresh water tank. The two vehicles have equivalent pumps and blast heads for the sake of comparison.

TABLE 1
Theoretical 13 hour shift for a 40,000 PSI vehicle with
gray water recycling according to the present disclosure.

| | | Fresh | Gray/ | |
|---|---|---|---|---|
| | Time | water | Recycled | Vacuum |
| First cycle | 7:00 AM | *2,000 | *3,000 | — |
| Consume fresh | 9:45 AM | — | 3,000 | 1,200 |
| Reload fresh | 9:50 AM | 2,000 | 1,000 | 1,200 |
| from gray tank | | | | |
| Dewater vacuum | 9:55 AM | 2,000 | 2,200 | — |
| to gray | | | | |
| Second cycle | 10:00 AM | ***2,000 | 2,200 | — |
| (recirculating gray | | | | |
| water through filters) | | | | |
| Consume fresh | 12:45 PM | — | 2,200 | 1,200 |
| Reload fresh | 12:50 PM | 2,000 | 200 | 1,200 |
| from gray tank | | | | |
| Dewater vacuum | 12:55 PM | 2,000 | 1,400 | — |
| to gray | | | | |
| Third cycle | 1:00 PM | ***2,000 | 1,400 | — |
| (recirculating gray | | | | |
| water through filters) | | | | |
| Consume fresh | 3:45 PM | — | 1,400 | 1,200 |
| Reload fresh | 3:50 PM | 1,400 | — | 1,200 |
| from gray tank | | | | |
| Dewater vacuum | 3:55 PM | 1,400 | 1,200 | — |
| to gray | | | | |
| Fourth cycle | 4:00 PM | ***1,400 | 1,200 | — |
| (recirculating gray | | | | |
| water through filters) | | | | |
| Consume fresh | 5:45 PM | — | 1,200 | 840 |
| Reload fresh | 5:50 PM | 1,200 | — | 840 |
| from gray tank | | | | |
| Dewater vacuum | 5:55 PM | 1,200 | 840 | — |
| to gray | | | | |
| Fifth cycle | 6:00 PM | ***1,200 | 840 | — |
| (recirculating gray | | | | |
| water through filters) | | | | |
| Consume fresh | 7:30 PM | — | 840 | 720 |
| End of shift disposal | 7:45 PM | — | **1,560 | — |

*Fresh water consumed
**Waste water generated
***Recycled water

TABLE 2
Theoretical 13 hour shift for a conventional 40,000 PSI vehicle.

| | Time | Fresh | Vacuum |
|---|---|---|---|
| First load | 7:00 AM | *2,000 | — |
| Consume fresh | 9:45 AM | — | **1,200 |
| Unload vacuum tank | 10:05 AM | — | — |
| Reload fresh | 10:25 AM | 2,000 | — |
| Second load | 10:30 AM | *2,000 | — |
| Consume fresh | 1:15 PM | — | **1,200 |
| Unload vacuum tank | 1:35 PM | — | — |
| Reload fresh | 1:55 PM | 2,000 | — |
| Third load | 2:00 PM | *2,000 | — |
| Consume fresh | 4:45 PM | — | **1,200 |
| Unload vacuum tank | 5:05 PM | — | — |
| Reload fresh | 5:25 PM | 2,000 | — |
| Fourth load | 5:30 PM | *2,000 | — |
| Consume fresh | 8:00 PM | 1,850 | **1,090 |
| Post operation | | | |
| Unload | | | |

*Fresh water consumed
**Waste water generated

In total, the 40,000 PSI vehicle with gray water recycling of the present disclosure would consume 5,000 gallons of fresh water, produce 1,560 gallons of waste water, and spend a total time of 11 hours and 30 minutes in operation. This compares with the conventional vehicle, which consumes 7,815 gallons of fresh water, generates of 4,690 gallons of waste water, and spends a total of 10 hours and 45 minutes in operation.

What is claimed is:

1. A paint removal vehicle comprising:
a fresh water tank;
a water pressure pump coupled with the fresh water tank, wherein the fresh water tank provides a water supply to the water pressure pump;
a blast head coupled with the water pressure pump, wherein the blast head is configured to spray a pressurized water supply from the water pressure pump and vacuum a gray water supply;
a vacuum tank coupled with the blast head, wherein the vacuum tank is configured to receive the gray water supply from the blast head;
a gray water tank coupled with the vacuum tank and the fresh water tank, wherein the gray water tank is configured to receive the gray water supply from the vacuum tank; and
a filter body coupled with the gray water tank, wherein the filter body is configured to circulate and filter the gray water supply of the gray water tank,
wherein the fresh water tank is configured to receive a water supply from the gray water tank.

2. The paint removal vehicle of claim 1, wherein the fresh water tank is coupled with the gray water tank.

3. The paint removal vehicle of claim 1, wherein the fresh water tank has a maximum capacity from about 1,500 gallons to about 4,500 gallons, and the gray water tank has a maximum capacity from about 2,500 gallons to about 5,000 gallons.

4. The paint removal vehicle of claim 1, wherein the water pressure pump is configured to deliver a pressurized water supply to the blast head at a pressure from about 32,000 PSI to about 40,000 PSI.

5. The paint removal vehicle of claim 4, wherein the water pressure pump is configured to deliver the pressurized water source to the blast head at a flow rate from about 10 gallons per minute to about 14 gallons per minute.

5. The paint removal vehicle of claim 1, wherein the water pressure pump is coupled with a a fuel tank, an integrated vacuum, or both.

6. The paint removal vehicle of claim 5, wherein the integrated vacuum further comprises a roots blower vacuum pump configured to deliver a gray water supply vacuumed by the blast head to the vacuum tank.

7. The paint removal vehicle of claim 1, wherein the water pressure pump is about 12 feet in length, about 8 feet in width, and does not exceed about 10 feet in height.

8. The paint removal vehicle of claim 1, wherein the filter body further comprises a filter pump for circulating a water supply between the gray water tank and the filter body.

9. The paint removal vehicle of claim 8, wherein the filter body further comprises a plurality of filters of varying filter ratings.

10. The paint removal vehicle of claim 9, wherein the varying filter ratings for the plurality of filters range from about 5 microns to about 100 microns.

11. The paint removal vehicle of claim 8, wherein the filter pump circulates a gray water supply from a lower portion of the gray water tank through the filter body and returns a filtered water supply to an upper portion of the gray water tank.

12. The paint removal vehicle of claim 1, wherein the vehicle further comprises a transfer pump between the vacuum tank and the gray water tank, said transfer pump configured to deliver the gray water supply from the vacuum tank to the gray water tank.

13. The paint removal vehicle of claim 12, wherein the vacuum tank further comprises a filter configured to separate the liquid gray water supply and any solid debris in the vacuum tank.

14. The paint removal vehicle of claim 1, wherein the vehicle further comprises at least one monitor of water level of the fresh water tank, water level of the vacuum tank, water level of the gray water tank, pressure of gray water circulating in the filter body, or any combination thereof.

15. The paint removal vehicle of claim 1, wherein the fresh water tank further comprises a low water level shutoff.

16. A process for removing materials from a surface, comprising the steps of:
a) providing a paint removal vehicle comprising a fresh water tank, a water pressure pump, a blast head, a vacuum tank, a gray water tank, and a filter body;
b) loading the fresh water tank and the gray water tank with clean water;
c) engaging the water pressure pump, wherein the fresh water tank supplies water to the water pressure pump, wherein the water pressure pump supplies pressurized water to the blast head;
d) spraying pressurized water with the blast head to remove materials from a surface;
e) vacuuming a gray water supply and debris materials with the blast head to send to the vacuum tank;
f) continuing steps d) and e) until the fresh water tank is empty or the vacuum tank is full;
g) pumping clean water from the gray water tank to the fresh water tank until the clean water tank is full;
h) pumping gray water from the vacuum tank to the gray water tank; and
i) continuously circulating gray water from the gray water tank to the filter body using a pump.

17. The process of claim 16, wherein the step of pumping gray water from the vacuum tank to the gray water tank further comprises separating an amount of solid debris from the gray water before delivering the gray water to the gray water tank.

18. The process of claim 16, wherein the filter body further comprises a plurality of filters having varying filter ratings ranging from about 5 microns to about 100 microns.

19. The process of claim 16, wherein the water pressure pump supplies the pressurized water to the blast head at a pressure from about 32,000 PSI to about 40,000 PSI and at a flow rate from about 10 gallons per minute to about 14 gallons per minute.

20. A paint removal vehicle comprising:
a fresh water tank;
a water pressure pump coupled with the fresh water tank, wherein the fresh water tank provides a water supply to the water pressure pump, the water pressure pump coupled with a fuel tank and an integrated vacuum;
a blast head coupled with the water pressure pump, wherein the blast head is configured to spray a pressurized water supply from the water pressure pump and vacuum a gray water supply, said pressurized water supply having a pressure range from about 32,000 PSI to about 40,000 PSI;
a vacuum tank coupled with the blast head, wherein the vacuum tank is configured to receive the gray water supply from the blast head;
a gray water tank coupled with the vacuum tank and the fresh water tank, wherein the gray water tank is configured to receive the gray water supply from the vacuum tank; and
a filter body coupled with the gray water tank, wherein the filter body is configured to circulate and filter the gray water supply of the gray water tank, the filter body further comprising a plurality of filters having varying filter ratings ranging from about 5 microns to about 100 microns,
wherein the fresh water tank is coupled with the gray water tank, and the fresh water tank is configured to receive a water supply from the gray water tank.
